(19) United States
(12) Patent Application Publication
(10) Pub. No.: US 2025/0046556 A1
(43) Pub. Date: Feb. 6, 2025

(54) OPERATING MECHANISM FOR A CIRCUIT BREAKER

(71) Applicant: Eaton Intelligent Power Limited, Dublin (IE)

(72) Inventors: Sandip KOTWAL, Pune (IN); Sunil BAROT, Pune (IN)

(21) Appl. No.: 18/788,319

(22) Filed: Jul. 30, 2024

(30) Foreign Application Priority Data
Aug. 3, 2023 (IN) 202311052366
Oct. 17, 2023 (GB) 2315886.8

(51) Int. Cl. H01H 71/10

(52) U.S. Cl. CPC H01H 71/10

(57) ABSTRACT

An mechanism that operates a circuit breaker has a frame that rotates about a first axis in response to user actuation; and actuators with first and second ends. The first ends are offset from each other in a first direction, and the second ends are offset from each other in a second direction. Each actuator moves in a third direction in response to a second user actuation at its first end. The first, second, and third directions are all different from each other. Two extension are rods also retained within the frame. In operation: when the frame is in a first position, the second ends of the actuators can actuate buttons of the circuit breaker, and when the frame is rotated to a second position, the extension rods actuate the buttons.

### CROSS REFERENCE TO RELATED APPLICATIONS

This application claims benefit to Indian Patent Application number 202311052366, filed on Aug. 3, 2023, as well as United Kingdom Application No. 2315886.8, filed on Oct. 17, 2023, which are hereby incorporated by reference herein.

### FIELD

The present disclosure relates to an operating mechanism for a circuit breaker, in some particular examples to an ON-OFF push button operating mechanism for a circuit breaker. The operating mechanism facilitates retrofitting of circuit breakers.

### BACKGROUND

Typically, circuit breakers are arranged within a cabinet having a door. The cabinet can be a medium voltage switchgear (MVS) with a vacuum circuit breaker (VCB) compartment door. A push button operating mechanism is coupled or mounted to an inside of the door. The operating mechanism facilitates user actuation of one or more operating buttons of the circuit breaker via separate user engagement buttons, which are located outside of the cabinet. The circuit breaker can thus be operated when the cabinet door is closed.

When retrofitting circuit breakers, it is desirable to use the same cabinet without changing or modifying the door, since changing the door design increases the cost of the retrofit. In some instances, critical internal arc tests may also need to be performed for the new door, further increasing the cost. However, the present inventors have recognized that a problem occurs when the new circuit breaker has operating buttons which are in a different orientation to those of the circuit breaker which is being replaced. The different orientation of the operating buttons leads to a mismatch between the user engagement buttons/operating mechanism and the operating buttons of the new circuit breaker.

It is, the present inventors have therefore recognized, desirable to improve facilitation of such circuit breaker retrofitting.

### SUMMARY

In an embodiment, the present disclosure provides an operating mechanism that operates a circuit breaker that has two operating buttons. The operating mechanism includes: a frame configured to rotate about a first rotation axis, from a first position to a second position, in response to a first user actuation; and two actuators, each having a first end and a second end. The respective first end of each the two actuators are offset from each other in a first direction. The respective second end of each of the two actuators are offset from each other in a second direction. Each actuator of the two actuators is configured to be moved in a third direction in response to a second user actuation at the respective first end of the respective actuator. The first direction, the second direction, and the third direction are all different from each other. Two extension are rods retained within the frame. The operating mechanism is configured such that, in operation: in a condition where the frame is in the first position, the respective second end of each of the two actuators respectively actuates one of the operating buttons of the circuit breaker in response to the second user actuation, and in a condition where the frame is in the second position, the two extension rods are aligned with the second ends of the two actuators, and the two extension rods respectively actuate the operating buttons of the circuit breaker in response to the second user actuation.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1A shows a perspective view of an exemplary embodiment of a circuit breaker and operating mechanism, demonstrating a mismatch between the user engagement buttons on an outside of a cabinet and the operating buttons of the circuit breaker within the cabinet with existing operating mechanisms;

FIG. 1B shows a perspective view of the circuit breaker with an exemplary embodiment of an operating mechanism implemented according to aspects of the present disclosure;

FIG. 2A shows a schematic illustration of a cross section of the operating mechanism described in a first position;

FIG. 2B shows a cross section of the operating mechanism of FIG. 2A at a different position along the third direction;

FIG. 3A shows a schematic illustration of a cross section of the operating mechanism described in a second position;

FIG. 3B shows a cross section of the operating mechanism of FIG. 3A at a different position along the third direction;

FIG. 4A shows a front view of a first example operating mechanism in the first position;

FIG. 4B shows a rear view of the first example operating mechanism of FIG. 4A;

FIG. 5 shows a first example implementation of an actuating component;

FIG. 6 shows a first example implementation of a means for rotating the frame;

FIG. 7A shows a front view of a second example operating mechanism in the first position;

FIG. 7B shows a rear view of the second example operating mechanism of FIG. 7A;

FIG. 8 shows a second example implementation of an actuating component;

FIG. 9 shows a second example implementation of a means for rotating the frame; and

FIG. 10 shows an exemplary system including the operating mechanism of FIG. 1B.

### DETAILED DESCRIPTION

Aspects of the present disclosure provide an operating mechanism for a circuit breaker, the circuit breaker having two operating buttons. The operating mechanism comprises a frame configured to rotate about a first rotation axis and means for rotating the frame about the first rotation axis, from a first position to a second position, in response to first user actuation. The operating mechanism further comprises two actuating components, each having a first end and a second end. The first ends of the two actuating components are offset from each other in a first direction, and the second ends of the two actuating components are offset from each other in a second direction. Each actuating component is configured to be moved in a third direction in response to second user actuation at the first end, wherein the first, second, and third directions are different. The operating mechanism also comprises two extension rods retained within the frame. In use, the operating mechanism is configured such that: when the frame is in the first position, the second ends of the two actuating components actuate the operating buttons of the circuit breaker in response to the second user actuation; and when the frame is in the second position, the two extension rods are aligned with the second ends of the two actuating components, and the two extension rods actuate the operating buttons of the circuit breaker in response to the second user actuation.

In this way, an operating mechanism can be provided that addresses issues with mismatch between operating buttons during retrofitting of a circuit breaker, without modification of the door or cabinet, and without modification of the circuit breaker. A quicker, cheaper, retrofitting may therefore be facilitated.

Optionally, when the frame is in the second position, the two extension rods extend parallel to the third direction. Optionally, the first, second, and third directions are mutually perpendicular. Optionally, the first, second, and third directions are substantially perpendicular to one another.

In some examples, the first direction is a horizontal direction and the first ends of the two actuating components are arranged alongside each other along the horizontal direction. Additionally or alternatively, the second direction is a vertical direction and the second ends of the two actuating components are arranged one above the other along the vertical direction. In this way, mismatch between the horizontally orientated user engagement buttons on the cabinet and the vertically orientated operating buttons of the retrofitted circuit breaker may be resolved without modification of the cabinet or circuit breaker.

Optionally, the operating mechanism further comprises one or more resilient members configured to bias the frame to rotate, about the first rotation axis, away from the second position and towards the first position. In the absence of user engagement or actuation to rotate the frame, the frame may thus be restored to the first position. The first position can be a default or rest position. In some examples, the first position is a test position for the circuit breaker and the second position is a service position for the circuit breaker. The operating mechanism may therefore default to the test position without user actuation.

In some examples, the means for rotating the frame comprises a rotatable portion configured to rotate about a second rotation axis in response to actuation by a user. The second rotation axis can be different to the first rotation axis. Optionally, the first rotation axis extends parallel to the second direction. Optionally, the second rotation axis is perpendicular to the first rotation axis. Optionally, the second rotation axis is parallel to the third direction.

The means for rotating the frame can further comprise a connecting portion pivotably coupling the rotatable portion to the frame, the connecting portion configured such that rotation of the rotatable portion about the second rotation axis causes rotation of the frame about the first rotation axis. Optionally, the connecting portion is pivotably coupled to the rotatable portion and rigidly coupled to the frame. In some examples, the frame is rigidly coupled to one or more pins of the operating mechanism, and the one or more pins are rotatable about the first rotation axis; in these examples, the connecting portion can be pivotably coupled to the rotatable portion and rigidly coupled to the one or more pins.

Optionally, the connecting portion is a rigid rod or other rigid component. Alternatively, the connecting portion is a flexible wire or cable.

In one example, each actuating component comprises a Z shaped rod. Each Z shaped rod can comprise a central portion angled relative to the first and second directions, and two end portions. The two end portions form the first and second ends of the actuating component. In some implementations, the two end portions extend in opposite directions from the central portion, each end portion extending parallel to the third direction.

In another example, each actuating component comprises a strip angled relative to the first and second directions, and a stud. The stud can be rigidly coupled to the strip. The stud forms the second end of the actuating component. In some implementations, the stud extends away from the strip, in a direction parallel to the third direction.

Optionally, wherein the two extension rods are formed of an insulating material. In some examples, the insulating material is a plastic material. The use of an insulating material can improve the safety and reliability of the system when the operating mechanism is deployed or disposed within a cabinet during use.

In some implementations, the operating mechanism further comprises one or more guides for each actuating component. In one example, the one or more guides comprise a plate having a slot, the slot configured to receive the second end of the actuating component. Additionally or alternatively, the one or more guides comprise one or more guide pins, each guide pin configured to be received by a corresponding aperture in the actuating component. The one or more guides can act to keep the actuating components in the correct orientation and position for actuating the operating buttons of the circuit breaker. A robust and reliable operating mechanism may therefore be provided.

A system comprising the operating mechanism is also disclosed. The system also comprises a cabinet having a door, an inside of the door partially defining a void within the cabinet. An outside of the door has two user engagement buttons offset from each other along the first direction, and a knob. The system further comprises a circuit breaker disposed within the void of the cabinet, the circuit breaker having two operating buttons offset from each other along the second direction. The operating mechanism is coupled to the inside of the door such that: the first ends of the two actuating components engage with the two user engagement buttons, and the knob is coupled to the means for rotating the frame. First user actuation of the knob causes the frame to rotate about the first rotation axis, and second user actuation of the two user engagement buttons causes a corresponding actuation of the two operating buttons by the operating mechanism.

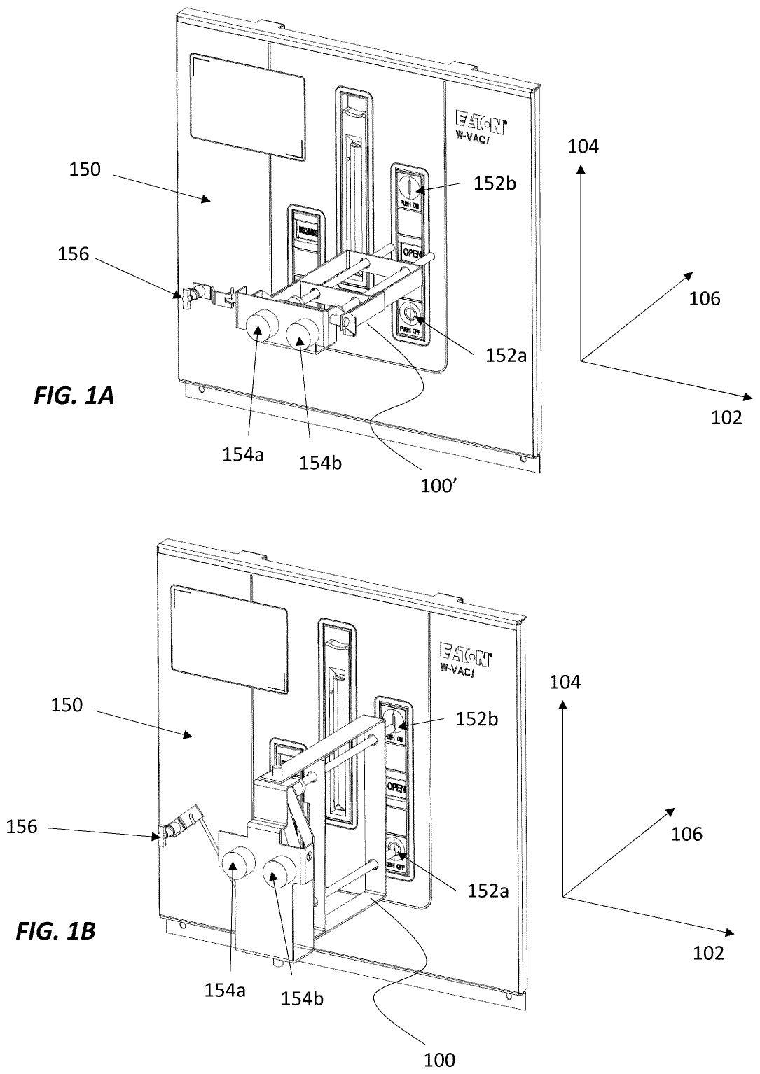

With reference to FIG. 1A, a perspective view of a circuit breaker 150 and existing operating mechanism 100′ is shown. The circuit breaker 150 is disposed within a void of a cabinet. The cabinet comprises a door. The operating mechanism 100′ is coupled to an inside of the door, between the door and the circuit breaker 150.

The circuit breaker comprises two operating buttons 152a, 152b. Actuation of these operation buttons operates the circuit breaker. Typically, the circuit breaker operating buttons 152a, 152b are actuated by way of user actuation applied to user engagement buttons 154a, 154b. These user engagement buttons are located on an outside of the door. This user actuation can here be a pushing of the buttons, i.e. an application of force along direction 106. The operating mechanism 100′ acts to transfer the force applied by a user to the user engagement buttons 154 (which are push buttons, with the force being applied by a user along direction 106) to the operating buttons 152 of the circuit breaker 150. However, a problem arises where the orientation of the circuit breaker operating buttons is different to the orientation of the user engagement buttons, as in FIG. 1A. This difference in orientation leads to a mismatch between the user engagement buttons 154 on the outside of the cabinet and the operating buttons 152 of the circuit breaker 150 within the cabinet. Such a mismatch occurs, for example, when retrofitting a new circuit breaker and replacing an older version or a version from another supplier of manufacturer.

In particular, it can be seen that the user engagement buttons 154 are offset from each other along a first direction 102 (here the horizontal direction), whilst the operating buttons 152 are offset from each other along a second direction 104 (here the vertical direction). As a result, the operating mechanism 100′, which is configured to be actuated by the user engagement buttons, does not align with the operating buttons 152 of the circuit breaker.

Whilst one solution would be to change the user engagement buttons to match the orientation of the operating buttons, this would require modification of the door. This increases the cost of the retrofit. Moreover, such a change would require the operator to retrain, as the operating interface would be different. Also, in some cases, the existing cabinet door has a transparent window in that region, which can make it difficult to provide new holes or modify the existing door. It is therefore desirable to provide an operating mechanism which resolves this mismatch, without changing the user engagement buttons 154 or operator interface, and without changing any other aspects of the door itself. Such an operating mechanism 100 is illustrated in FIG. 1B.

From FIG. 1B, it can be seen that the operating mechanism 100 allows the existing user engagement buttons 154a, 154b to be used to actuate the operating buttons 152a, 152b of the circuit breaker 150. Operating mechanism comprises actuating components (“actuators”) having first ends which are offset from each other in the first direction 102, and second ends which are offset from each other in the second direction 104. In this way, the mismatch in orientation can be resolved. Operating mechanism 100 can replace operating mechanism 100′ of FIG. 1A without modification of the door or cabinet, and without modification of the circuit breaker. A quicker, cheaper, retrofitting may therefore be facilitated by use of the operating mechanism 100 described herein. Moreover, such retrofitting can help to reduce or avoid the risk of internal arcing due to modifications of the cabinet door.

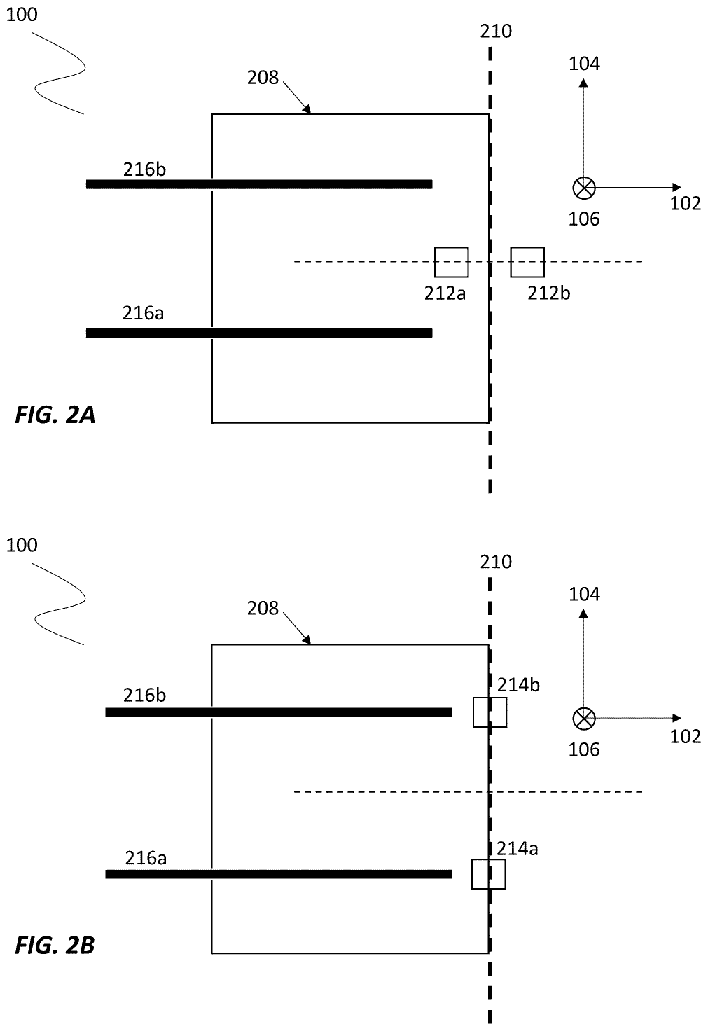

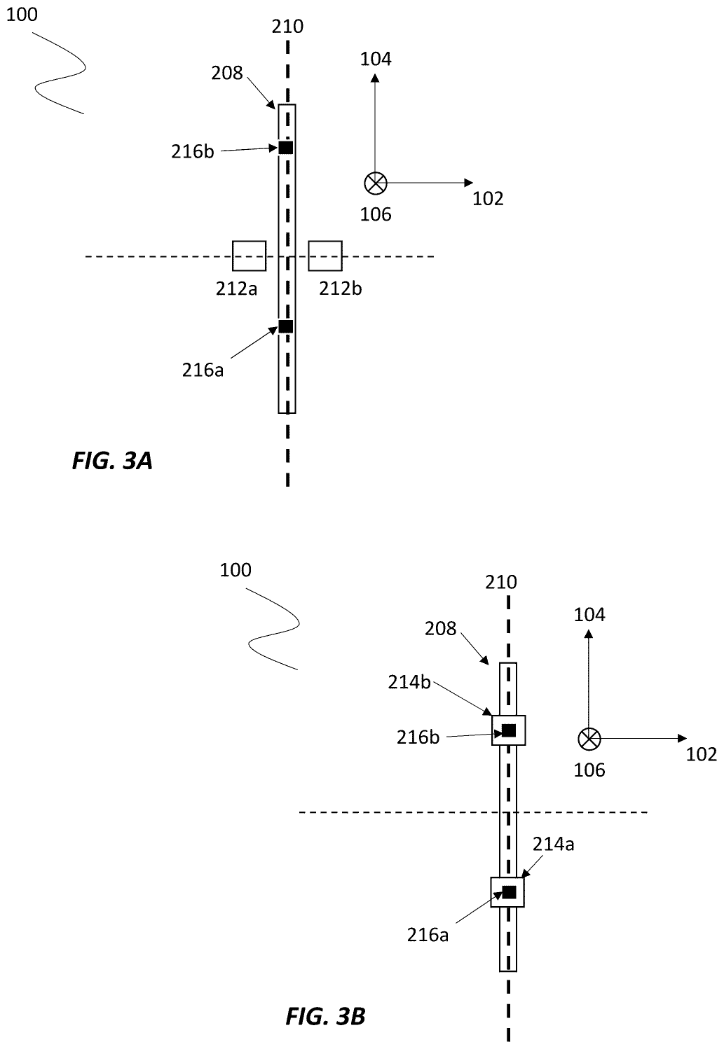

Operating mechanism 100 will now be described in more detail with reference to FIGS. 2A, 2B, 3A and 3B. FIGS. 2A, 3A are cross sectional schematic views taken from a first location along direction 106 and FIGS. 2B, 3B are cross sectional schematic views taken from a second location along direction 106.

The operating mechanism 100 comprises a frame 208. The frame 208 is configured to rotate about a first rotation axis 210. The frame 208 rotates from a first position (shown in FIGS. 2A, 2B) to a second position (shown in FIGS. 3A, 3B). In the first position the frame lies along direction 102 (hereinafter the first direction 102, or horizontal direction) and in the second position the frame lies along direction 106 (hereinafter the third direction 106). The frame rotates about the first rotation axis 210, which in this example extends parallel to direction 104 (hereinafter the second direction 104, or vertical direction). In this example, the first, second and third directions are mutually perpendicular, but it will be understood that other arrangements are possible.

In some examples, the first position is a test position of the circuit breaker and the second position is a service position of the circuit breaker. The frame 208 rotates from the first to the second position because the circuit breaker 150 is configured to move back within the cabinet in direction 106 during a service; this movement of the circuit breaker increases the distance between the circuit breaker and the door, so the operating mechanism is configured to rotate to allow actuation of the circuit breaker in the service position. This movement of the circuit breaker is known to the skilled person, and occurs also with existing operating mechanism 100′, so will not be described further here.

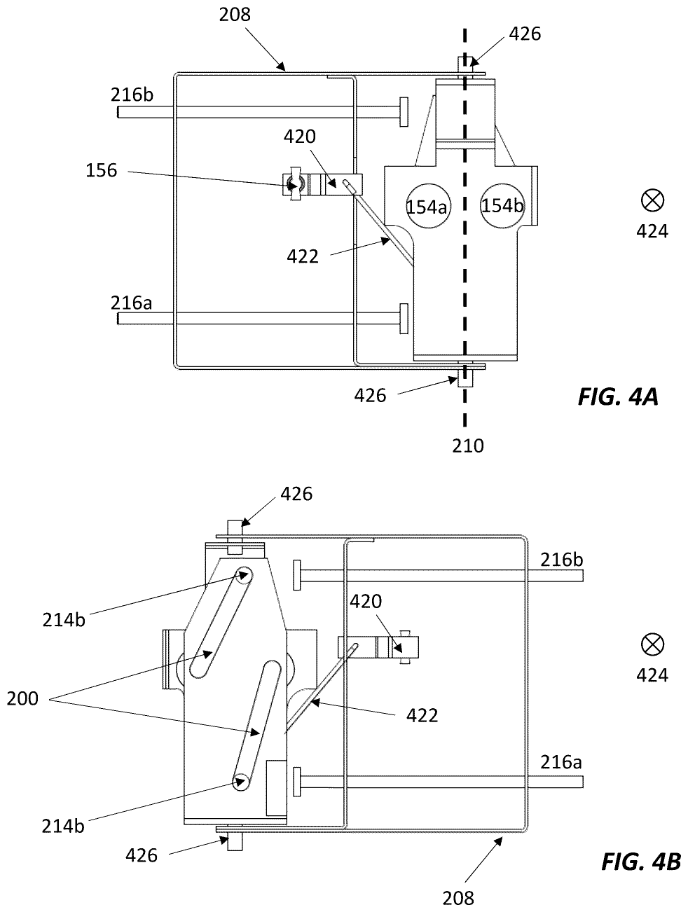

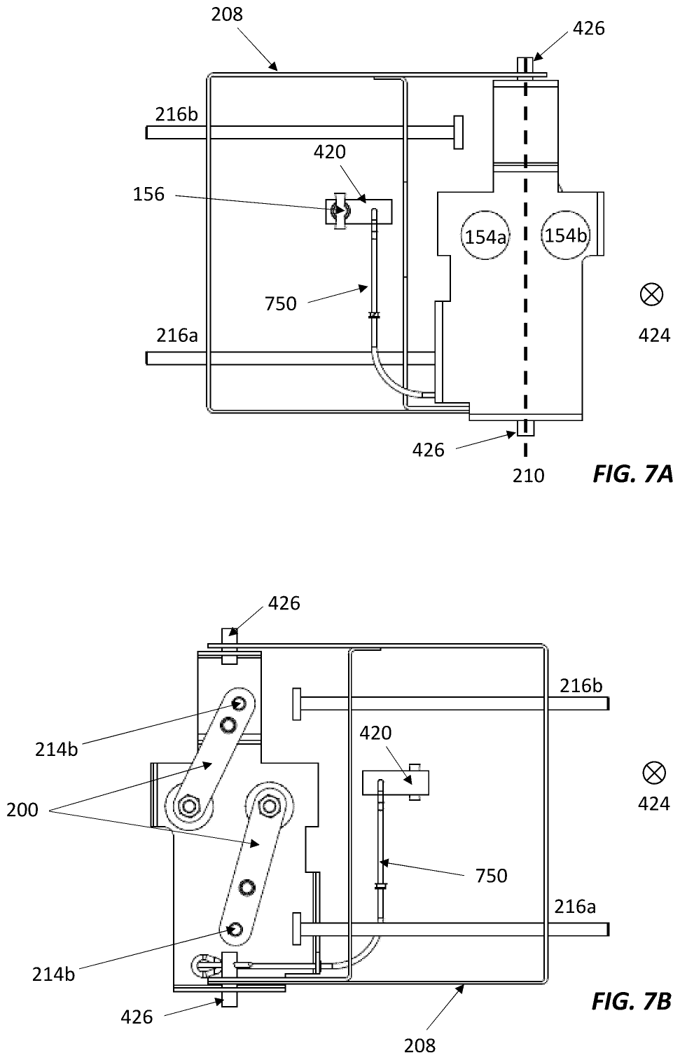

The rotation of the frame 208 occurs in response to first user actuation of a means for rotating the frame (described further with reference to FIGS. 4A, 4B, 7A and 7B). For rotating, the frame can be actuated by knob 156 (shown in FIGS. 1A, 1B), which knob is also coupled or arranged on the outside of the cabinet housing the circuit breaker 150. One or more resilient members or other biasing means can also be provided. The resilient member(s) can be configured to bias the frame 208 to cause the frame to rotate, about the first rotation axis 210, away from the second position and towards the first position. In this way, when a user lets go of the knob 156 or otherwise stops applying force to rotate the frame 208, the frame is biased back towards the first position. This allows the circuit breaker 150 to be moved back to the test position after servicing without the frame 208 hindering any such movement by being in the second position. The resilient member(s) can be resilient by form and/or material. In some examples, the resilient members can comprise one or more torsion or extension springs (or a compression spring, depending on the arrangement and location of the spring). In other examples, the resilient member is resilient by material, and may be e.g. an elastic or rubber member arranged to bias the frame towards the first position.

The operating mechanism further comprises two actuating components (reference 200, described further with reference to FIGS. 4A, 4B, 7A and 7B). Each actuating component comprises a first end 212a, 212b and a second end 214a, 214b. The first ends 212a, 212b of the two actuating components are configured to engage with the two user engagement buttons 154a, 154b. The first ends are shown in FIGS. 2A, 3A. The second ends 214a, 214b are configured to cause actuation of the operating buttons 152a, 152b of the circuit breaker 150. The second ends are shown in FIGS. 2B, 3B. It can be seen that the first ends of the two actuating components are offset from each other in the first direction 102, and the second ends of the two actuating components are offset from each other in the second direction 104. In other words, in this example, the first ends 212 of the two actuating components are arranged alongside each other along the horizontal direction 102 and the second ends 214 of the two actuating components are arranged one above the other along the vertical direction 104. In other examples, the first ends may be arranged along the vertical direction and the second ends may be arranged along the horizontal direction, depending on the configuration of the cabinet and circuit breaker. Any suitable arrangement or configuration of actuating component may be used, provided the first and second ends are offset along different directions/axes, in the manner described, to address any mismatch between buttons of the cabinet and circuit breaker.

When in use, the operating mechanism 100 is configured such that when the frame is in the first position, the second ends 214a, 214b of the two actuating components actuate the operating buttons 152a, 152b of the circuit breaker 150 in response to user actuation of the engagement buttons 154a, 154b. In particular, each actuating component is configured to be moved in the third direction 106 in response to user actuation at the first end via the engagement buttons. The user actuation can be a pushing of the engagement buttons or any other application of force that causes a force component along the third direction 106 to cause the actuating component to be moved in the direction 106.

The operating mechanism 100 further comprises two extension rods 216, 216b which are retained within, or held by, the frame 208. The frame can comprise holes or apertures through which the extension rods extend and through which the extension rods can move in a linear direction. Since the extension rods 216 are (moveably) retained within/held by the frame, they rotate with the frame about the first rotation axis 210. As such, when the frame is in the second position, the two extension rods are aligned with the second ends 214 of the two actuating components, and the two extension rods actuate the operating buttons 152a, 152b of the circuit breaker 150 in response to the user actuation. The extension rods 216a, 216b thus allow for operation of the operating buttons 152 of the circuit breaker 150 in the second (service) position, i.e. by extending the actuation of the actuating components in the third direction through the frame. In this particular example the extension rods are straight and extend parallel to the third direction, but other configurations are possible. In this way, the extension rods can move (through the holes/apertures) in the third direction relative to the frame. The extension rods can be formed from an insulating material. Optionally, the extension rods are formed from a plastic material.

A simple and reliable operating mechanism can be provided which facilitates retrofitting of circuit breakers having different button orientations. Example arrangements of the operating mechanism 100 will now be discussed in more detail.

With reference to FIGS. 4A, 4B, a first example of the operating mechanism 100 is described. The operating mechanism comprises the frame 208, which is optionally rigidly coupled to one or more pins 426. The one or more pins extend along the first rotation axis 210. There may be a single pin extending along the first axis of rotation 210, or there may be multiple pins, in some specific examples there are two pins-one at a top of the frame and one at a bottom of the frame. The frame may be rigidly coupled to the pin(s) 426, wherein the one or more pins 426 are rotatable about the first rotation axis 210. In other examples, the frame may be rotatably coupled to the pin(s), which themselves may be rigidly coupled to e.g. the door of the cabinet or other fixed component; the pin(s) 426 may thus form the first rotation axis 210.

As discussed above, the operating mechanism comprises the means for rotating the frame about the first rotation axis 210. The means for rotating the frame comprises a rotatable portion 420 and a connecting portion 422. The rotatable portion 420 is configured to rotate about a second rotation axis 424 in response to actuation by a user (e.g. in response to user rotation of knob 156 about the second rotation axis 424). The second rotation axis 424 is different to the first rotation axis 210. Optionally, as shown here, the second rotation axis 424 is substantially perpendicular to the first rotation axis 210 and parallel to the third direction, though other configurations are possible.

The connecting portion 422 pivotably couples the rotatable portion 420 to the frame 208, and is configured such that rotation of the rotatable portion 420 about the second rotation axis 424 causes rotation of the frame 208 about the first rotation axis 210. In this example, the connecting portion is pivotably coupled to the rotatable portion and rigidly coupled (either directly or indirectly) to the frame 208 in order to facilitate rotation of the frame 208 in response to rotation of the rotatable portion. Specifically, in the arrangement shown in FIGS. 4A and 4B, both the frame 208 and the connecting portion 422 are rigidly coupled to a bottom one of the pin(s) 426. However, any other suitable arrangement can be used to cause rotation of the frame 208 about the first rotation axis.

With particular reference to FIG. 6, the connecting portion is a rigid rod 422. The connecting portion 422 comprises a pin 670 or other coupling component configured to rigidly couple the rigid rod to the bottom pin 426 (or frame). The rigid rod 422 can also comprise a portion which passes through a hole or aperture in the rotatable portion 420, dimensioned to allow the rigid rod 422 to pivot or rotate within the hole. In other examples, the cable 750 can be otherwise pivotably coupled to the rotatable portion 420.

As discussed above, the operating mechanism of FIGS. 4A, 4B also comprises the two actuating components 200. The actuating components are configured such that the first ends 212 are offset along the first, horizontal, direction and the second ends 214 are offset along the second, vertical, direction.

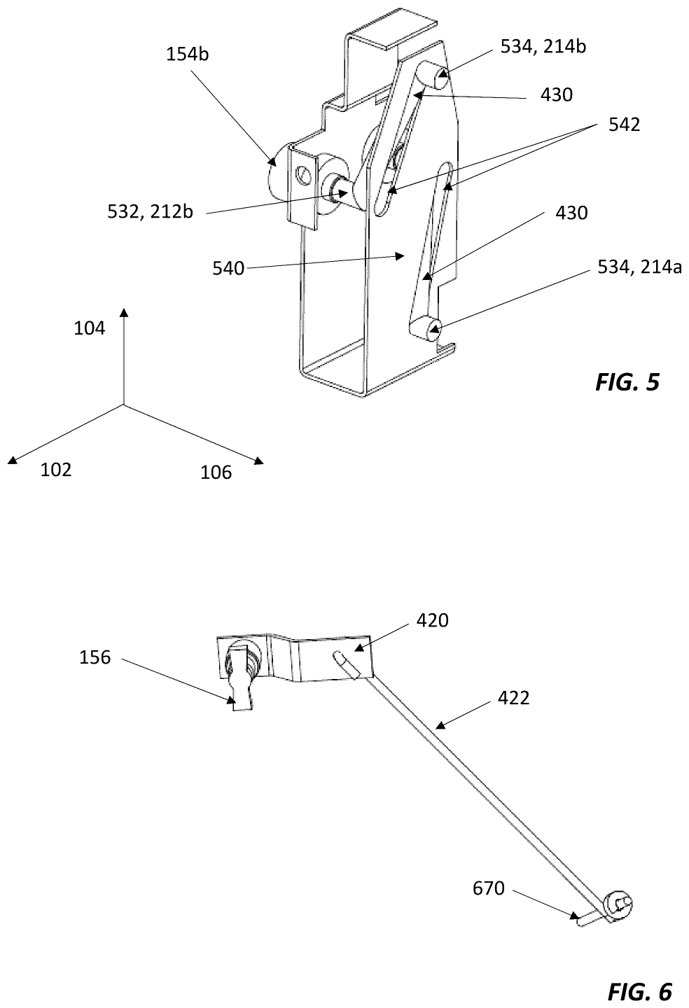

With particular reference to FIG. 5, each actuating component 200 comprises a Z shaped rod. Each Z shaped rod comprises a central portion 430. The central portion can be angled relative to the first and second directions to facilitate the transition between the orientations of the first ends 212 and the second ends 214. In some arrangements, the central portion can lie within a plane defined by the first and second directions. In other arrangements, as can be seen in FIG. 5, the central portion 430 of each actuating component can be angled respective to each of the first 102, second 104, and third 106 directions. Each Z shaped rod also comprises two end portions 532, 534. The two end portions extend in opposite directions from the central portion, each end portion extending parallel to the third direction. The Z shaped rod can be formed from a single piece, or formed of multiple pieces which are joined or coupled together. The Z shaped rod can be formed of an insulating material, optionally, a plastic material. The Z shaped rod can be manufactured in any suitable manner, as appropriate to the choice of material.

The two end portions 532, 534 of the Z shaped rod form the first and second ends 212, 214 of the respective actuating component 200. The end portion 532 (the portion of the Z shaped rod which is distal from the extension rod 216) is configured for engagement with the user engagement buttons 154, in order that the actuating component 200 can move in the third direction 106 in response to user actuation of the respective engagement button 154. In some particular examples, the end portion 532 is rigidly coupled to a back or rear of the user engagement button 154. In one implementation, the end portion 532 is rigidly mounted on the back/rear of button 154. For example, the end portion 532 may couple to the user engagement button via a press fit, snap fit, or interference fit mechanism, though it will be understood that other arrangements are possible. In other examples, the end portion 532 may simply be arranged proximate, or touching, the back of the user engagement button 154 such that actuation of the button actuates the Z shaped rod.

In some examples, as illustrated in FIG. 5, the operating mechanism 100 further comprises one or more guides for each actuating component. In this example, the one or more guides comprise a plate 540. The plate may be rigidly coupled to the door or cabinet when in use. The frame 208 can be configured to rotate with respect to the plate 540. The plate 540 comprises a slot 542, which slot is configured to receive the second end 534 (214a, 214b) of the actuating component 200. Each actuating component may be associated with a separate slot 542. The slots 542 may be formed in a single plate 540, as shown in FIG. 5, or there may be multiple plates, each plate acting as a guide for a separate actuating component. The guides act to keep the actuating components in the correct orientation and position for actuating the operating buttons of the circuit breaker. A robust and reliable operating mechanism may therefore be provided.

With reference to FIGS. 7A, 7B, a second example of the operating mechanism 100 is described. The operating mechanism comprises the frame 208, which is optionally rigidly coupled to one or more pins 426. The one or more pins extend along the first rotation axis 210. There may be a single pin extending along the first axis of rotation 210, or there may be multiple pins, in some specific examples there are two pins-one at a top of the frame and one at a bottom of the frame. The frame may be rigidly coupled to the pin(s) 426, wherein the one or more pins 426 are rotatable about the first rotation axis 210. In other examples, the frame may be rotatably coupled to the pin(s), which themselves may be rigidly coupled to e.g. the door of the cabinet or other fixed component; the pin(s) 426 may thus form the first rotation axis 210.

As discussed above, the operating mechanism comprises the means for rotating the frame about the first rotation axis 210. The means for rotating the frame comprises a rotatable portion 420 and a connecting portion 750. The rotatable portion 420 is configured to rotate about a second rotation axis 424 in response to actuation by a user (e.g. in response to user rotation of knob 156 about the second rotation axis 424). The second rotation axis 424 is different to the first rotation axis 210. Optionally, as shown here, the second rotation axis 424 is substantially perpendicular to the first rotation axis 210 and parallel to the third direction, though other configurations are possible.

The connecting portion 750 pivotably couples the rotatable portion 420 to the frame 208, and is configured such that rotation of the rotatable portion 420 about the second rotation axis 424 causes rotation of the frame 208 about the first rotation axis 210. In this example, the connecting portion is pivotably coupled to the rotatable portion and rigidly coupled (either directly or indirectly) to the frame 208 in order to facilitate rotation of the frame 208 in response to rotation of the rotatable portion. Specifically, in the arrangement shown in FIGS. 7A and 7B, both the frame 208 and the connecting portion 750 are rigidly coupled to a bottom one of the pin(s) 426. However, any other suitable arrangement can be used to cause rotation of the frame 208 about the first rotation axis.

With particular reference to FIG. 9, the connecting portion is a flexible wire or cable 750. The wire/cable 750 comprises a rigid pin 962 or other coupling component at one end. The rigid pin 962 is configured to rigidly couple the flexible connecting portion 750 to the bottom pin 426 (or frame). The other end of the cable 750 can also comprise a portion which passes through a hole or aperture in the rotatable portion 420, dimensioned to allow the cable to pivot or rotate within the hole. In other examples, the cable 750 can be otherwise pivotably coupled to the rotatable portion 420.

As discussed above, the operating mechanism of FIGS. 7A, 7B also comprises the two actuating components 200. The actuating components are configured such that the first ends 212 are offset along the first, horizontal, direction and the second ends 214 are offset along the second, vertical, direction.

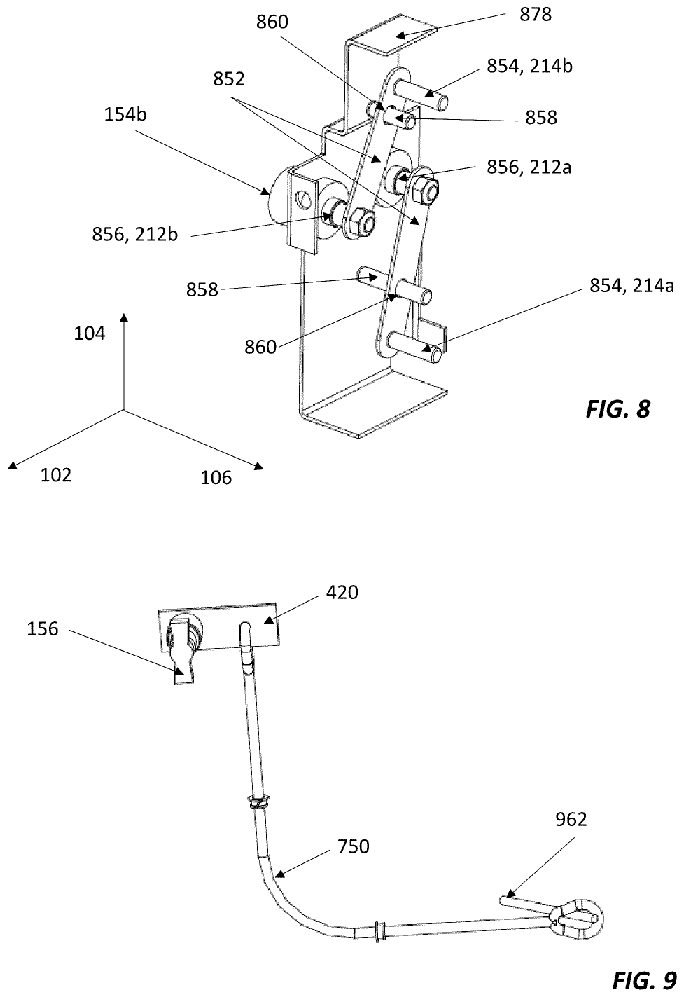

With particular reference to FIG. 8, each actuating component 200 comprises a strip 852. The strip 852 can be angled relative to the first and second directions to facilitate the transition between the orientations of the first ends 212 and the second ends 214. In some arrangements, as can be seen in FIG. 8, the central portion can lie within a plane defined by the first and second directions. In other arrangements, the strip 852 of each actuating component can be angled respective to each of the first 102, second 104, and third 106 directions. Each actuating component also comprises a stud 854 and a fixing portion 856. The stud 854 and the fixing portion 856 extend in opposite directions from the strip, with the stud 854 extending parallel to the third direction. The stud 854 forms the second end 214 of the respective actuating component 200, and the fixing portion 856 forms the first end 212 of the actuating component 200.

The strip 852 can be formed from a single piece, or formed of multiple pieces which are joined or coupled together. The strip can be formed of a metal or of an insulating material, optionally, a plastic material. The stud 854 may also comprise, or be formed from, an insulating material, and may be coupled to the strip 852 in any suitable manner. In the examples described herein, the strip is a single piece formed from sheet metal, with a self-clinching press stud fixed onto it to make permanent joint between strip 852 and stud 854 (i.e., stud 854 is a press stud). Instead of press studs, a weld stud could be used to form 854, which stud would be welded to the sheet metal strip 852. However, other arrangements are possible, as may be required by the application.

The fixing portion 856 (the end of the actuating component distal from the extension rod 216) is configured for engagement with the user engagement buttons 154, in order that the actuating component 200 can move in the third direction 106 in response to user actuation of the respective engagement button 154. In some particular examples, the fixing portion is machine and rigidly coupled to, or formed integral with, a rear (or back) of the engagement buttons 154. For example, the fixing portion 856 can be a threaded component rigidly coupled to the user engagement button 154. This additional fixing portion 856 can be used to fix the strip 852 and stud 854 to the user engagement buttons. For example, a bolt (optionally a hexagonal bolt) can be used to fix the strip to the fixing portion. In other examples, the fixing portion can be machined and rigidly coupled to, or formed integral with, the strip; the fixing portion can then be rigidly fixed to the engagement button 154 in any suitable way, optionally using a threaded portion which is received by a corresponding thread of the button 154. The fixing portion can be any suitable component or mechanism configured to couple or join the strip 852 to the rear of the user engagement button 154.

In some examples, as illustrated in FIG. 8, the operating mechanism 100 further comprises one or more guides for each actuating component. In this example, the one or more guides comprise a guide pin 858. The guide pin 858 may be rigidly coupled to the door or cabinet when in use. In some particular examples shown herein, the guide pin 858 is a press stud or weld stud which is fixed to a sheet metal part 878 that is itself rigidly fixed or coupled to the door. However, any suitable arrangement may be used to provide guide pin 858. The frame 208 can thus be configured to rotate with respect to the guide pin 858, such that the guide pin 858 remains fixed as the frame 208 rotates about the first rotation axis 210. Each guide pin 858 is configured to be received by a corresponding aperture (hole, slot or opening) in the actuating component 200. Here, the aperture is formed in the strip 852 of the actuating component. Each actuating component may be associated with a separate guide pin 858 as shown in FIG. 8, as a single guide pin may be sufficient to maintain the desired orientation/angle of the actuating component 200. However, optionally, there may be multiple guide pins 858 for each actuating component. The guide pins act to keep the actuating components in the correct orientation and position for actuating the operating buttons of the circuit breaker. A robust and reliable operating mechanism may therefore be provided.

In the figures, the actuating components of FIG. 5 are shown in combination with the connecting portion of FIG. 6, and the actuating components of FIG. 8 are shown in combination with the connecting portion of FIG. 9. However, it will be understood that the actuating components of FIG. 5 can be combined with the connecting portion of FIG. 9, and the actuating components of FIG. 8 can be combined with the connecting portion of FIG. 6. Moreover, any other suitable arrangements of actuating components and/or connecting portions (or means for rotating the frame) can be provided in any suitable combination. Furthermore, the guide portions of FIGS. 5 and 8 can be combined with the actuating components in any suitable manner; for example, the guide portion of FIG. 5 can be used with the actuating component of FIG. 8, and vice versa (e.g., the stud 854 could extend through a slot 852, or an aperture 860 could be formed in the central portion 430 of the Z shaped rod so as to receive a guide pin 858).

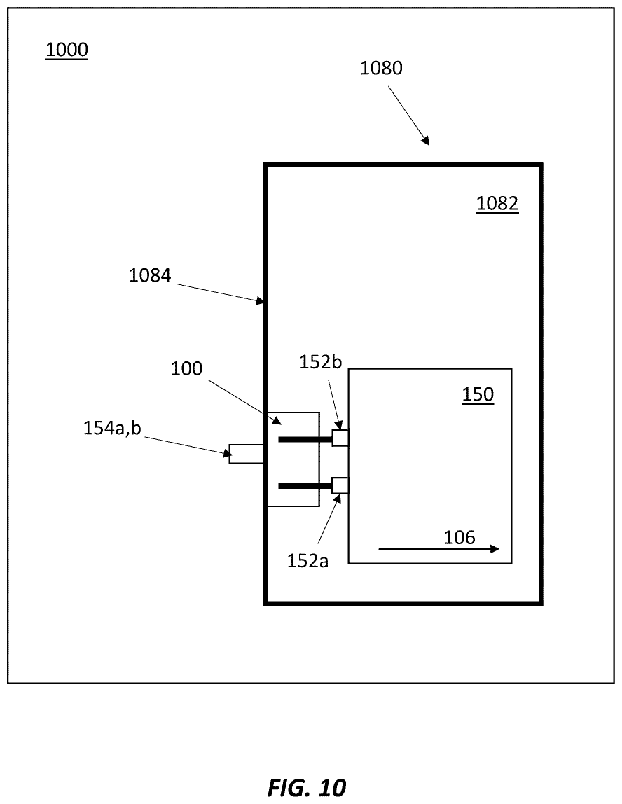

With reference to FIG. 10, a system 1000 is now described. The system comprises an operating mechanism 100 as described herein. The system also comprises a cabinet 1080 having a door 1084, an inside of the door partially defining a void 1082 within the cabinet. The cabinet could be a switchgear cabinet or any other suitable electrical cabinet for housing a circuit breaker. A circuit breaker 150 is disposed within the void of the cabinet.

An outside of the door has two user engagement buttons 154a, 154b offset from each other along the first direction 102, and a knob 156. The circuit breaker has two operating buttons 152a, 152b offset from each other along the second direction 104. The operating mechanism is disposed between the door 1084 and the circuit breaker 150. In particular, the operating mechanism 100 is coupled to the inside of the door such that the first ends 212a, 212b of the two actuating components 200 engage with the two user engagement buttons, and such that the knob is coupled to the means for rotating the frame.

The system 1000 is configured such that, in use, first user actuation of the knob causes the frame to rotate about the first rotation axis (between the first position and the second position, as discussed above), and second user actuation of the two user engagement buttons causes a corresponding actuation of the two operating buttons by the operating mechanism (indirectly via the extension rods, as discussed above). This second position of the frame is a service position of the circuit breaker, in which the circuit breaker has moved to the right of FIG. 10, along the third direction 106 (to accommodate the rotation of the frame). However, when the frame is in the first position, the circuit breaker is in a test position, and the circuit breaker is closer to the door 1084. In this test position, the knob 154 is inactive, and the frame does not rotate. The second ends of the two actuating components thus directly actuate the operating buttons of the circuit breaker in response to the second user actuation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An operating mechanism for a circuit breaker comprising two operating buttons, the operating mechanism comprising:
a frame configured to rotate about a first rotation axis, from a first position to a second position, in response to a first user actuation;
two actuators, each comprising a first end and a second end, wherein:
the respective first end of each the two actuators are offset from each other in a first direction, and the respective second end of each of the two actuators are offset from each other in a second direction, and
each actuator of the two actuators is configured to be moved in a third direction in response to a second user actuation at the respective first end of the respective actuator, wherein the first direction, the second direction, and the third direction are all different from each other; and
two extension rods retained within the frame,
wherein the operating mechanism is configured such that, in operation:
in a condition where the frame is in the first position, the respective second end of each of the two actuators respectively actuates one of the operating buttons of the circuit breaker in response to the second user actuation, and
in a condition where the frame is in the second position, the two extension rods are aligned with the second ends of the two actuators, and the two extension rods respectively actuate the operating buttons of the circuit breaker in response to the second user actuation.

2. The operating mechanism of claim 1, wherein the operating mechanism is configured such that:
in the condition where the frame is in the second position, the two extension rods extend parallel to the third direction; and
the first direction, the second direction, and the third direction are mutually perpendicular from each other.

3. The operating mechanism of claim 1, wherein the first direction is a horizontal direction and the respective first end of both of the two actuators are arranged alongside each other along the horizontal direction, and wherein the second direction is a vertical direction and the respective second end of both of the two actuators are arranged one above the other along the vertical direction.

4. The operating mechanism of claim 1, further comprising one or more resilient members configured to bias the frame to rotate, about the first rotation axis, away from the second position and towards the first position.

5. The operating mechanism of claim 1, further comprising:
a rotatable portion configured to rotate about a second rotation axis in response to the first actuation by the user, the second rotation axis being different to the first rotation axis, and
a connecting portion pivotably coupling the rotatable portion to the frame, the connecting portion configured such that rotation of the rotatable portion about the second rotation axis causes rotation of the frame about the first rotation axis.

6. The operating mechanism of claim 5, wherein:
the first rotation axis extends parallel to the second direction; and/or
wherein the second rotation axis is perpendicular to the first rotation axis; and/or
wherein the second rotation axis is parallel to the third direction.

7. The operating mechanism of claim 5, wherein the connecting portion is:
a rigid rod); or
a flexible wire.

8. The operating mechanism of claim 5, wherein the connecting portion is pivotably coupled to the rotatable portion and rigidly coupled to the frame.

9. The operating mechanism of claim 1, further comprising one or more pins, wherein the frame is rigidly coupled to the one or more pins, and wherein the one or more pins are rotatable about the first rotation axis.

10. The operating mechanism of claim 1, wherein each of the actuators comprises a Z shaped rod, each Z shaped rod comprising:
a central portion angled relative to the first direction and the second direction; and
two end portions forming the respective first end and the respective second end of the respective one of the actuators, the two end portions extending in opposite directions from the central portion, each end portion extending parallel to the third direction.

11. The operating mechanism of claim 1, wherein each of the actuators comprises:
a strip angled relative to the first direction and the second direction; and
a stud rigidly coupled to the strip and forming the respective second end of each of the two actuators, the stud extending away from the strip in a direction parallel to the third direction.

12. The operating mechanism of claim 1, wherein the two extension rods are formed of an insulating material.

13. The operating mechanism of claim 1, further comprising one or more guides for each of the actuators, the one or more guides comprising:
a plate comprising a slot, the slot configured to receive the respective second end of the each actuating component; and/or
one or more guide pins, each guide pin configured to be received by a corresponding aperture in the each of the actuators.

14. The operating mechanism of claim 1, wherein the first position of the frame corresponds to a test position, and wherein the second position of the frame corresponds to a service position.

15. A system comprising:
the operating mechanism of claim 1;
a cabinet comprising a door, an inside of the door partially defining a void within the cabinet, an outside of the door comprising: two user engagement buttons offset from each other along the first direction, and a knob; and
the circuit breaker disposed within the void of the cabinet, the circuit breaker comprising the two operating buttons offset from each other along the second direction,
wherein the operating mechanism is coupled to the inside of the door such that: the respective first end of each of the two actuators engage with the two user engagement buttons, and the knob is coupled to the frame for actuating the rotating of the frame,
wherein the first user actuation of the knob is configured to cause the frame to rotate about the first rotation axis, and
wherein the second user actuation of the two user engagement buttons is configured to cause a corresponding actuation of the two operating buttons by the operating mechanism.

16. The operating mechanism of claim 1, wherein the two extension rods are formed of a plastic material.
